(19) United States
(12) Patent Application Publication
(10) Pub. No.: US 2004/0202170 A1
(43) Pub. Date: Oct. 14, 2004

(54) Implementing priority for multiple physical layer devices at a UTOPIA interface

(75) Inventors: Yochai Parchak, Raanana (IL); Zvika Menachemi, Modi'in (IL); Yair Laster, Modi'in (IL)

Correspondence Address: Fogg, Slifer & Polglaze, P.A., P.O. Box 581009, Minneapolis, MN, 55458-1009, US

(73) Assignee: ADC Telecommunications Israel Ltd.

(21) Appl. No.: 09/804,930

(22) Filed: Mar. 13, 2001

(51) Int. Cl. H04L 12/28

(52) U.S. Cl. 370/395.1; 370/466

(57) ABSTRACT

A matrix card is provided. The matrix card includes a plurality of physical layer devices. Each of the physical layer devices is adapted to support cells of first and second priorities and including a controllable port. The ports are in operative communication with each other to provide for the transmission of all cells of the first priority from all of the plurality of physical layer devices before transmitting any cells of the second priority from all of the plurality of physical layer devices.

### TECHNICAL FIELD

The present invention relates generally to the telecommunications field, and in particular, embodiments of the present invention are directed to implementing priority for multiple physical layer devices at a Universal Test and Operations Physical Interface for ATM (“UTOPIA”) interface.

### BACKGROUND

Asynchronous Transfer Mode (ATM) is a layered architecture allowing for multiple services, such as voice, data and video to be mixed over networks. ATM has grown out of the need for a worldwide standard to allow for interoperability of information, regardless of the end system or type of information. The goal of ATM is for a single international standard.

ATM is typically divided into three levels for its implementation, an adaption layer, an ATM layer and a physical layer. The adaption layer assures the appropriate service characteristics and divides all types of data into the 48 byte payload that makes up the ATM cell. The ATM layer takes the data to be sent and adds the 5 byte header information, that assures the cell is sent to the right connection, and the physical layer, is the lowest layer, and defines the electrical characteristics and network interfaces.

The ATM layer and physical layer can communicate by a standardized data path called Universal Test and Operations Physical Interface for ATM (“UTOPIA”). The UTOPIA specification provides 53 bytes of 8 bit wide bytes or 16 bit wide words with 27 words per cell. One UTOPIA that is typically used is a UTOPIA Level 2, which is multi-user, as several physical layer devices can be multiplexed on it. The UTOPIA Level 2 is detailed in “Utopia Level 2, Version 1.0”, The ATM Forum Technical Committee, June 1995, this document incorporated by reference herein.

Present connections via UTOPIA busses exhibit drawbacks, in that cell delay priority between physical layer devices can not be implemented. This is because the standard UTOPIA interface lacks any structure for determining priority among cells. As a result, high priority cells, for example, Constant Bit Rate (CBR) cells from one physical layer device, and low priority cells, for example, non-CBR cells, from another physical layer device, are transmitted in sequential order, and not in accordance with priority.

### SUMMARY

Embodiments of the present invention provide for cell delay priority between physical layer devices, interfaced to an ATM layer by a UTOPIA bus, such that high priority cells, e.g., CBR cells, in the respective physical layer devices are transmitted to the ATM layer prior to any low priority, e.g., non-CBR cells, in these physical layer devices. This is accomplished by the design of a pin in each physical layer device, referred to as the “Priority Status Port” (PSP). The PSPs are connected along a common line or bus. When a high priority buffer in a physical layer device is not empty, the PSP goes to a selected voltage level. In this condition, the physical layer devices without high priority cells are prevented from loading low priority cells to the UTOPIA interface. Thus, if any of the physical layer devices have high priority cells, none of the physical layer devices will pass low priority cells to the UTOPIA bus. However, each physical layer device is allowed to transmit any high priority cells in this condition. Low priority cells are only sent if all high priority queues are empty as indicated by the PSPs.

### BRIEF DESCRIPTION OF THE DRAWINGS

Attention is now directed to the attached drawings, wherein like reference numeral or characters indicate corresponding or like components.

FIG. 1 is a schematic diagram of an embodiment of the present invention.

FIG. 2 is an block diagram of an embodiment of a physical layer device with a priority status port according to the teachings of the present invention.

FIG. 3 is a block diagram of an embodiment of a PSP Control Circuit according to the teachings of the present invention.

FIG. 4 is a flow diagram of a process for transmitting cells in accordance with an embodiment of the present invention.

### DETAILED DESCRIPTION

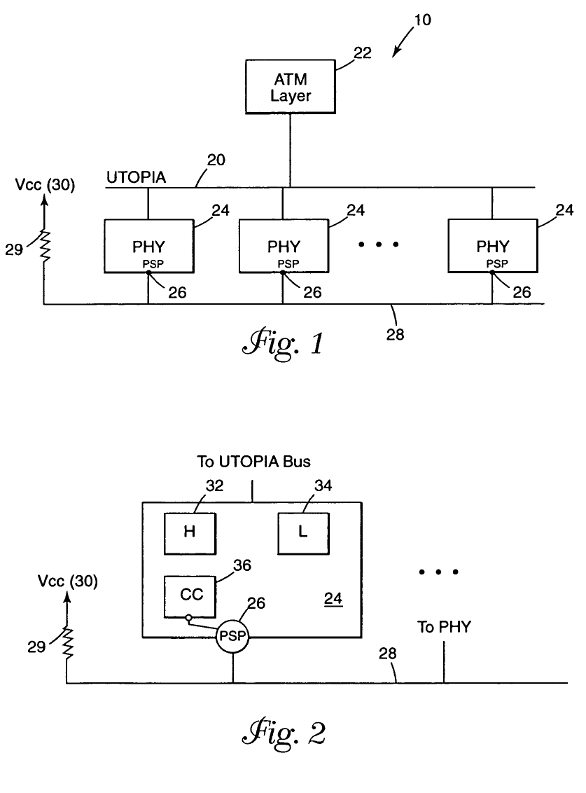

FIG. 1 is a block diagram of an embodiment of the present invention in an exemplary operation as part of a matrix card indicated generally at 10. Here, there is a UTOPIA bus 20, intermediate an ATM layer 22 and physical layer devices 24, for example, ATM Distributors (ATMXs). The UTOPIA bus 20 serves as the data path for cell travel between the physical layer devices 24 and the ATM layer 22. Each physical layer device (PHY) 24 includes a priority status port (PSP) 26. In one embodiment, PSP 26 is an open collector port. The PSPs 26 are each connected along a common bus or line 28 that includes a resistor 29 and terminates in a VCC 30.

In operation, matrix card 10 provides ATM cells from physical layer devices 24 to ATM layer 22 through UTOPIA bus 20. Physical layer devices 24 provide cells to UTOPIA bus 20 in a round robin fashion. Matrix card 10 supports transmission of cells of a plurality of priority levels, e.g., high and low priority levels. Each physical layer device 24 maintains a queue for traffic of each priority level, e.g., a high priority queue and a low priority queue. If a selected physical layer device 24 has high priority traffic, the physical layer device 24 pulls the bus 28 to ground. This signal level on bus 28 indicates to the other physical layer devices 24 that only high priority traffic can be transmitted to the UTOPIA bus 20. When only high priority traffic is transmitted, it is transmitted in round robin fashion by physical layer devices with high priority traffic in their respective queues. Further, each physical layer device 24 monitors the status of bus 28 at its PSP port 26 to determine whether low priority traffic can be transmitted to UTOPIA bus 20. In one embodiment, when bus 28 is at a high voltage level, low priority traffic can be transmitted by any of the physical layer devices 24 in round robin fashion.

Advantageously, the use of PSP ports 26 and bus 28 prevents low priority traffic on any physical layer device 24 from being sent to the UTOPIA bus 20 when at least one of the physical layer devices 24 has high priority traffic in its high priority queue as indicated by the signal on bus 28. Thus, high priority traffic is given true priority even though multiple physical layer devices with distinct high priority queues share the same UTOPIA bus.

FIG. 2 is a block diagram of one embodiment of physical layer devices 24 of FIG. 1. Physical layer devices 24, in one embodiment, are application specific integrated circuits (ASIC) used to serialize ATM cells and distribute the ATM cells through Low Voltage Differential Signal (LVDS) ports and vice versa. In one embodiment, the physical layer devices 24 are configured to support a plurality of buffer queues; typically FIFO buffer queues. For example, physical layer devices 24 are configurable to support two buffer queues; namely, a high priority buffer (H) 32 for high priority cells such as for CBR traffic (CBR cells), and a low priority buffer (L) 34 for low priority cells such as non-CBR traffic (non-CBR cells). The high priority buffer (H) 32 is coupled to a PSP Control Circuit or PSP Control Block (CC) 36, that in turn, is coupled to the PSP 26. While “n” physical layer devices 24 are shown in FIG. 1, this is exemplary only as embodiments of the invention are suitable for use with two or more physical layer devices 24. In one embodiment, thirty-two physical layer devices 24 are provided.

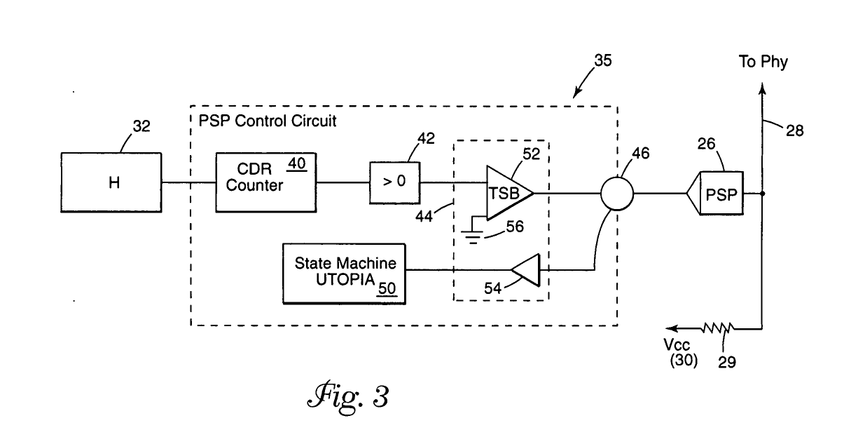

FIG. 3 is a block diagram of an embodiment of a PSP Control Circuit, indicated generally at 36, and constructed according to the teachings of the present invention. PSP control circuit 36 includes a CBR counter 40, coupled to a comparator 42. Comparator 42 is in turn coupled to a bidirectional tri-state buffer (TSB) 44. The TSB 44 is coupled to a pin 46 and a State Machine 50 for the UTOPIA. This state machine 50 controls the UTOPIA interface by controlling the CLAV (an indication for Cell Available from the UTOPIA Slave to Master) from the high priority buffer 32 to the UTOPIA bus 20. By controlling in this manner, the state machine 50 monitors for the receipt of high priority cells, and monitors if such cells can be transmitted or received.

The tri-state buffer 44 has both an output buffer 52 and an input buffer 54. The output buffer 52 connects to the comparitor 42 and is grounded, via the ground 56. The output buffer is also coupled to the PSP 26, via the pin 46.The PSP 26 is also connected to the common bus or line 28. Input buffer 54 couples the state machine 50 and the PSP 26, and therefore to the bus line 28. This line 28 connects to the respective PSPs of the other physical layer devices 24 and the VCC 30, as detailed above with respect to FIG. 1.

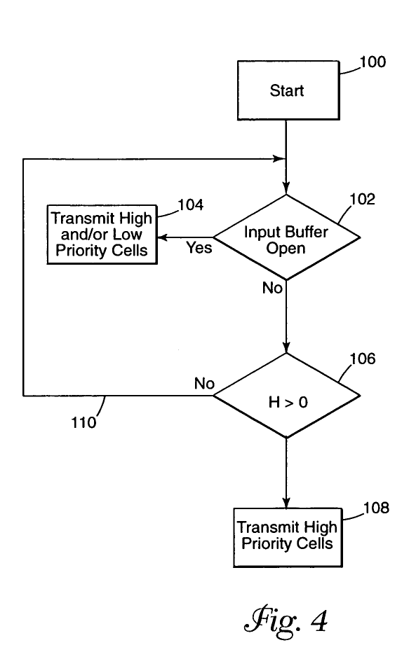

FIG. 4 details an exemplary operation of the embodiment of the PSP Control Circuit 36 in the form of a flow diagram. The process starts at block 100. The process determines whether the input buffer 54 status is open (“0”) or closed (“1”), at block 102. The closed status of input buffer 54 corresponds to the situation in which other physical layer devices have high priority traffic in their respective queues. The open status indicates that the other physical layer devices do not have high priority traffic in their respective queues. Thus, with the input buffer 54 open, both high and low priority cells can be transmitted from the physical layer device, at block 104.

If the input buffer 54 is closed or “1”, only high priority cells can be transmitted. The comparitor 42 analyzes the signal associated with the cell at block 106. If the signal is greater than “0”, that is “1”, the cell is high priority cell. Prior to reaching the comparitor 42, a high priority cell has caused the counter 40 to change from “0” to “1”. Otherwise, all functions within the PSP Control Circuit 36 remain the same.

If the cell is high priority, as per the comparitor 42, the cell is transmitted at block 108. Otherwise, if the cell is low priority, a feedback 110 will start the process again.

When the comparitor 42 detects a high priority cell, it signals the tri-state buffer 44, that is grounded, and opens it. Opening of the tri-state buffer 44, pulls down the pin 46 that opens the PSP 26 and pulls down the line 28, precluding other physical layer devices 24 from allowing for transmissions of cells to the UTOPIA bus 20. This transmission of a high priority cell also brings the state machine 50 up to “1”. As long as high priority cells are being transmitted, the state machine will remain “up” at “1”.

Alternatively, when the pin 46 is not active, the line 28 is pulled “up”, by the resistor 29 unless another physical layer device has high priority data in its queue. In this non-active state, with line 28 pulled “up”, this particular physical layer device 24 is not transmitting cells unless none of the other physical layer devices 24 have high priority cells in their respective buffers.

While preferred embodiments of the present invention have been described, so as to enable one of skill in the art to practice the present invention, the preceding description is intended to be exemplary only. It should not be used to limit the scope of the invention, which should be determined by reference to the following claims.

What is claimed is:

1. A matrix card comprising:
a plurality of physical layer devices, each of said physical layer devices adapted to support cells of first and second priorities and including a controllable port, said ports in operative communication with each other to provide for the transmission of all cells of said first priority from all of said plurality of physical layer devices before transmitting any cells of said second priority from all of said plurality of physical layer devices.

2. The matrix card of claim 1, wherein said physical layer devices each comprise:
a first buffer for supporting cells of said first priority;
a second buffer for supporting cells of said second priority; and
a controller in communication with said first buffer and said port.

3. The matrix card of claim 2, wherein said controller comprises:
a counter;
a state machine; and
a buffer operably coupled to said counter and said state machine.

4. The matrix card of claim 2, wherein said ports are connected along a bus.

5. A matrix card, comprising:
an ATM layer device;
a plurality of physical layer devices, each physical layer device having first and second queues for cells of first and second priority levels, respectively, and a priority status port;
a first bus, coupled between the physical layer devices and the ATM device, wherein the physical layer devices access the first bus in a round robin fashion; and
a second bus, coupled to the priority status port of each of the physical layer devices, the second bus providing an indication as to whether any of the physical layer devices has cells in its respective first queue to allow for priority handling of cells in the first queue.

6. The matrix card of claim 5, wherein the first bus comprises a UTOPIA bus.

7. The matrix card of claim 5, wherein the physical layer devices each have a high priority queue for constant bit rate traffic and a low priority queue for non-constant bit rate traffic.

8. The matrix card of claim 5, wherein the physical layer devices each include a control circuit that is adapted to ground the second bus when cells are stored in the first queue of any of the physical layer devices.

9. A method for controlling access to a bus for a plurality of physical layer devices, the method comprising:
determining when any of the physical layer devices has priority traffic in a queue;
when priority traffic is queued in any of the physical layer devices, transmitting the priority traffic; and
when there is no priority traffic queued, transmitting other traffic from the plurality of physical layer devices.

10. The method of claim 9, wherein transmitting priority traffic comprises transmitting priority traffic in a round robin fashion among the physical layer devices having priority traffic in their respective queues.

11. The method of claim 9, wherein transmitting other traffic comprises transmitting other traffic in a round robin fashion from physical layer devices with traffic in their respective queues.

12. The method of claim 9, wherein determining when any of the physical layer devices has priority traffic in a queue comprises determining when any of the physical layer devices have constant bit rate traffic.

13. A physical layer device, comprising:
first and second queues for processing cells with first and second priorities, respectively;
a priority status port, the priority status port adapted to communicate a status signal with other physical layer devices; and
a control circuit, coupled to the priority status port, adapted to allow cells of the first priority to be transmitted when the status signal is a first level and that allows cells of the second priority to be transmitted when the status signal is a second level.

14. The physical layer device of claim 13, wherein the first queue is a queue for constant bit rate traffic.

15. The physical layer device of claim 13, wherein the priority status port drives a bus to a low voltage level when cells are stored in the first queue.

16. A method for controlling access to a bus for a plurality of physical layer devices, the method comprising:
determining when any of the physical layer devices has at least one cell in a priority queue;
when at least one cell is in the priority queue, providing a signal with a first level to the plurality of physical layer devices;
when the signal is at the first level, transmitting the priority traffic only; and
when the signal is at a second, different level, transmitting other traffic from the plurality of physical layer devices.

17. The method of claim 16, wherein transmitting priority traffic comprises transmitting priority traffic in a round robin fashion among the physical layer devices having priority traffic in their respective queues.

18. The method of claim 16, wherein transmitting other traffic comprises transmitting other traffic in a round robin fashion from physical layer devices with traffic in a non-priority queue.

19. The method of claim 16, wherein determining any of the physical layer devices has at least one cell in a priority queue comprises determining when any of the physical layer devices have constant bit rate traffic.

20. A matrix card comprising:
a plurality of physical layer devices, each of the physical layer devices adapted to transmit cells of first and second priorities; and
each of the plurality of physical layer devices including a status port, the status ports in operative communication with each other to provide for the transmission of cells of the first priority from the plurality of physical layer devices in round robin fashion before transmitting any cells of the second priority from the plurality of physical layer devices.
